(19) United States
(12) Patent Application Publication
(10) Pub. No.: US 2002/0153648 A1
(43) Pub. Date: Oct. 24, 2002

(54) Manufacturing method for composite transverse leaf spring

(76) Inventor: Robert C. Lawson, San Diego, CA (US)

Correspondence Address: Michael P. Chu, BRINKS HOFER GILSON & LIONE, P.O. BOX 10395, CHICAGO, IL, 60610, US

(21) Appl. No.: 10/037,048

(22) Filed: Dec. 31, 2001

Related U.S. Application Data
(60) Provisional application No. 60/215,422, filed on Jun. 30, 2000.
(60) Provisional application No. 60/276,370, filed on Mar. 17, 2001.

(51) Int. Cl. F16F 1/368; B29C 70/44

(52) U.S. Cl. 267/148; 264/103; 267/149; 264/257; 264/236; 264/314; 425/129.1; 425/389

(57) ABSTRACT

A transverse leaf spring structure and a manufacturing method for a composite transverse leaf spring is disclosed. The leaf spring is formed using a pre-formed tubular fiberglass fabric comprising longitudinally aligned and braided fiberglass fibers. The fabric is installed over an interior form, such as one or more inflatable bladders, and positioned within a forming mold. After resin is applied and cured to an appropriate stiffness within the mold, the mold is removed. The interior form is then removed from the composite leaf spring.

### CROSS-REFERENCE TO RELATED APPLICATIONS

The present application is a continuation-in-part application of U.S. Serial No. ______, Docket No. 199-1959, filed on May 5, 2001 and entitled “Wheel Suspension System Having An Integrated Link, Spring, and Anti-Roll Bar,” which in turn claims priority from U.S. Provisional Patent Application Serial No. 60/215,422, filed Jun. 30, 2000 and entitled “Method of Manufacturing Cross-Car Leaf Spring and Article Produced Thereby.” The present application also claims priority to U.S. Provisional Patent Application Serial No. 60/1276,370, filed Mar. 17, 2001. All of the above cases are incorporated herein in their entirety by reference.

### FIELD OF THE INVENTION

The present invention relates generally to a composite leaf spring for automobiles. More particularly, it relates to an automotive composite leaf spring manufacturing method.

### BACKGROUND OF THE INVENTION

Automotive suspension systems commonly utilize a combination of multiple linkages or control arms, coil springs, and anti-roll bars to support and cushion a vehicle and its passengers. Many truck suspension systems may use steel leaf springs and a solid axle (such as a Hotchkiss type system). Conventional suspension systems utilizing these common steel components are typically difficult to package within a vehicle, and are heavy, which contributes to poor fuel economy. Conventional known steel leaf springs utilize multiple secondary steel leaves of decreasing lengths secured below and parallel to a main steel leaf to provide cushioning under variable load conditions.

The use of composite materials in the manufacture of composite leaf springs offers much lighter and more compact designs. A method for weaving a non-flat, contoured transverse leaf spring has been proposed. One limitation of that manufacturing method is that the spring could not be a hollow beam. Another limitation is that the width of the beam section could be changed across the length of the spring. The weaving method also had limitations in varying the thickness along the length of the beam. These limitations resulted in additional material in the component that was very lightly stressed, and hence a component which was heavier and more expensive than needed. Even with these limitations, the proposed example incorporating woven material was 60% lighter than the components it replaced on a typical, non-transverse spring automotive application.

Because a transverse spring is loaded in an essentially 4-point bending configuration, the main stresses are caused by the bending moments. The stiffness of the spring is thus directly related to the area moment of inertia of the section. The material in the central area of a solid rectangular section of a composite spring does not significantly contribute to the bending stiffness. It would thus be beneficial to manufacture a composite spring having a hollow cross-section that would allow the hollow sections to be much lighter, yet have the same stiffness as a solid area in the previous example.

### SUMMARY OF THE INVENTION

In accordance with the present invention, a method and apparatus for manufacturing a composite leaf spring is provided herein. In one aspect of the invention, the method includes the steps of providing a forming means and a mold adapted to receive the forming means, and installing a pre-braided tubular fiberglass structure over the forming means. The braid structure preferably comprises a plurality of elongated fibers arranged to form an elongated, elastic tubular structure. The forming means is then placed with the braid structure into a mold cavity within the mold. A resin material is injected into the mold to cover the fibers, and the resin is cured to create an integrated leaf spring component.

In another aspect of the invention, a system for manufacturing a transverse leaf spring is provided. The system or apparatus comprises forming means having a shape corresponding to the leaf spring, and means for placing a pre-braided tubular fiberglass structure over the forming means. The braid structure comprises a plurality of elongated fibers arranged to form an elongated, elastic tubular structure. A mold cavity is adapted to receive the forming means and the braid structure and means are provided for injecting a resin material into the mold cavity.

In yet another aspect of the invention, a method for manufacturing a transverse leaf spring is provided. The method includes the steps of providing a braided fiber structure comprising a plurality of elongated fibers arranged to form an elongated, elastic tubular structure, integrating a resin material into the fiber structure to form a hollow molded spring shape, and curing the shape.

In yet another aspect of the invention, a composite transverse leaf spring is provided comprising a braided fiber structure comprising a plurality of elongated fibers arranged to form an elongated, elastic tube. The tube defines a substantially hollow interior extending susbstantially the length of the fiber structure. A resin material is integrated with the fiber structure to form a leaf spring shape having a substantially hollow interior and tapered ends. The tapered ends are adapted to pivotally attach to axle components of a vehicle.

### BRIEF DESCRIPTION OF THE DRAWINGS

FIG. 1 shows an exemplary transverse leaf spring, preferably formed of composite materials, positioned within a special suspension system of the present invention;

FIG. 1a shows a conventional spring, link, and anti-roll bar suspension assembly;

FIG. 2 shows a perspective view of an embodiment of the transverse leaf spring of the present invention;

FIG. 3 shows a top plan view of the embodiment shown in FIG. 2 above;

FIG. 4 shows a perspective view of the preferred embodiment of FIG. 2 above, in association with its molding structures;

FIG. 5 is a flow diagram showing the preferred method of the present invention; and

FIG. 6 shows a perspective view of the installation of the fiberglass tubular matrix over a forming means in accordance with the preferred embodiment of the invention.

### DETAILED DESCRIPTION OF THE PREFERRED EMBODIMENTS OF THE INVENTION

1. Transverse Leaf Spring

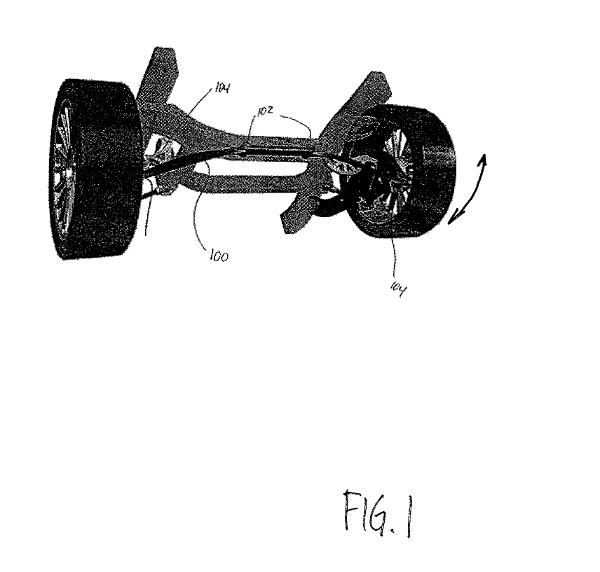

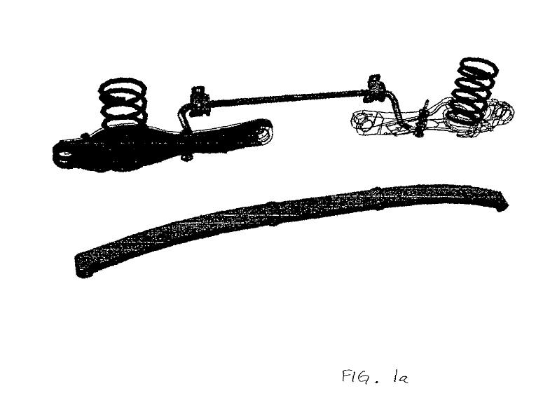

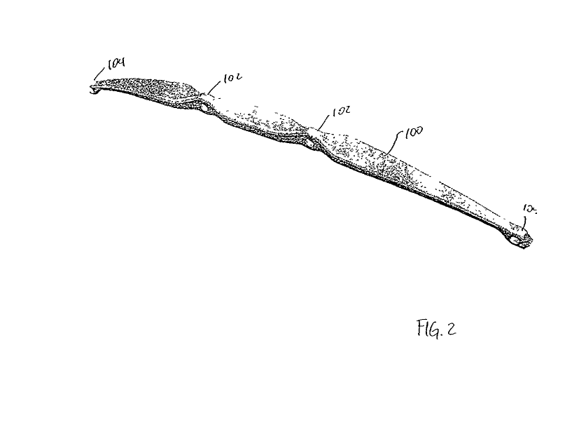

Composite leaf spring beam structures integrate multiple automotive suspension functions into one integral unit. The functions of suspension linkage, spring, and anti-roll bar are integrated to reduce part count, weight, NVH transmission, and complexity. The design can reduce part count on the order of 10 to 1, and weight on the order of 5 to 1. This invention incorporates the integration of a composite, transversely positioned spring to function as a locating member or link that also provides ride and roll stiffness functionality. The composite beam configuration as disclosed herein replaces the conventional lower control arms, coil springs, and anti-roll bar assembly with a single composite beam 100, as illustrated in FIGS. 1 and 2. By designing the shape of the beam 100, the material system and the pivot locations 102, the ride and roll rates, camber and toe characteristics of a conventional suspension system can be preserved. The use of such a composite beam may therefore reduce weight, complexity and cost of a suspension system in an automobile vehicle.

A conventional suspension of this type typically consists of a trailing arm and three lateral links, as shown in FIG. 1a. Lateral flex in the trailing arm as well as bushing compliance prevents the system from being kinematically over-constrained throughout the normal range of suspension travel. This design allows the trailing arm to locate the axle fore/aft and react to the braking moment loads, while the three lateral links provide camber and toe control of the wheel.

Due to the trailing arm suspension design, the axle moves along an arc as shown in the view of FIG. 1. The outer pivots 104 on the transverse leaf spring 100 beam must also follow an arc. The beam must flex both vertically and fore/aft. The beam is free to flex in the Y direction, and in doing so it controls the toe.

To reduce stresses and forces in the beam due to the fore/aft bending of the beam as the outer pivot follows the arc, a beam is implemented having a cross section whose bending axis is angled in the XZ plane. This results in a beam that travels fore/aft as well as vertically when loaded with only a vertical load at the outer pivots 104.

2. Manufacturing Method

In accordance with the present invention, a method for manufacturing a cross-car leaf spring for use in an improved rear suspension system is provided. The system typically incorporates trailing arms. The single-piece cross-car spring replaces the lower control arms, coil springs, and anti-roll bar assembly. The cross-car spring can be designed to have equivalent ride and roll stiffness as a baseline system that utilizes conventional componentry.

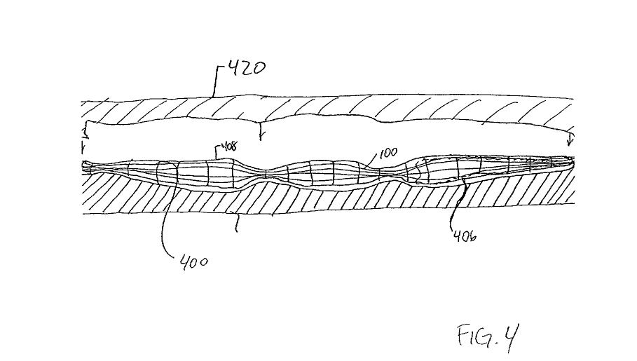

In accordance with the present invention, a tubular fiberglass base fabric structure that is pre-braided in various configurations is utilized in a composite structure in a transverse spring. Preferably, the fabric 400, as shown in FIG. 4, is pre-formed or braided into a flexible, tubular shape that may be stretched over a form before being integrated with resin. Exemplary fiberglass base materials are manufactured by A&P Technology under the trade name “Unimax.” These materials are provided in braids of fiberglass having various tube shapes. These braids can resemble a “Chinese finger trap,” for example, or a long tube of elongated, aligned fibers, such as a corn husk or flexible elastic tube sock. Preferably, the tubular structure is elastic both longitudinally and radially. Other braid patterns can be incorporated, such as “overbraiding.”As noted above, Unimax is a fiber, flexible tube structure 400 that contains mostly unidirectional fibers. That is, most of the fibers (elongated fibers 408) run along the length of the tube. In the alternative, the fibers may extend longitudinally in a helix around the length of the tube structure. In the preferred embodiment, these fibers are held in place by +/−45 degree mesh of braided elastic yarns. These tube structures can be pulled over a variety of elongated, contoured shapes quite easily, while still maintaining the glass fibers at a 0 degree fiber angle. In an exemplary method as shown in FIG. 4, a fiber preform for a spring could be created by cuffing a plurality of these tube structures and placing them over an inflatable bladder 405 in either an automated or manual process. The preform and bladder are then placed into a two-part mold or tool 420. Next, the bladder is inflated to a pressure of approximately 100 psi. The part may then be infused with resin using an injection means known in the art and molded using an RTM or VRTM process as is known in the art. Once the part has cured, it can be removed from the mold 420. Holes can be drilled at the pivots, and bushings can be inserted into the spring.

Tapers and wall thickness variations can be designed into the part shape, yielding an extremely lightweight and efficient component. Because tapers can be accommodated, the design can include tapers in width and weight from the inner pivots to the outer pivots in the beam section. This allows the outer regions to be more compliant, and hence the outer regions can contribute more to the total deflection than cross-car spring having constant cross-section. In such prior art springs, most of the deflection is due to strain near the inner pivots.

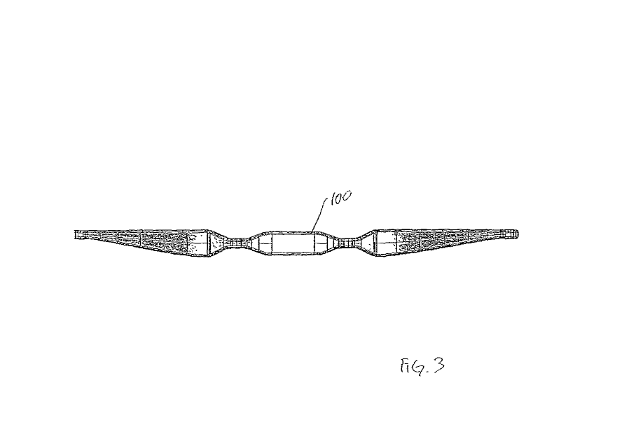

The spring can also be designed to have improved recession (fore/aft) compliance. Because these springs are typically designed to function in trailing-arm type rear suspensions, the outer pivots must follow an arc when viewed from the side of the vehicle. This causes the spring to have to flex fore/aft and/or rotate slightly at the inner bushings. The conventional woven material springs are very stiff in the fore/aft direction, which makes designing the inner bushings difficult, and may not allow sufficient recession compliance. The beam section near the inner pivots can be designed to be thin as viewed in a top view (FIG. 3, 100), and tall as viewed from the rear (FIG. 2, 102). This allows for a member that is more compliant fore/aft with lower stresses than the prior art woven composite spring.

Finally, sufficient weight savings may be achieved. As an example, a bladder molded spring was designed to replace the lower control arms, coil springs, and anti-roll bar assembly in a prototype vehicle. The spring was found to have a mass of 1.8 kg, as compared to 10.0 kg for the steel baseline components it replaces (82% weight savings). A similar 3D woven design was found to weigh 4.0 kg.

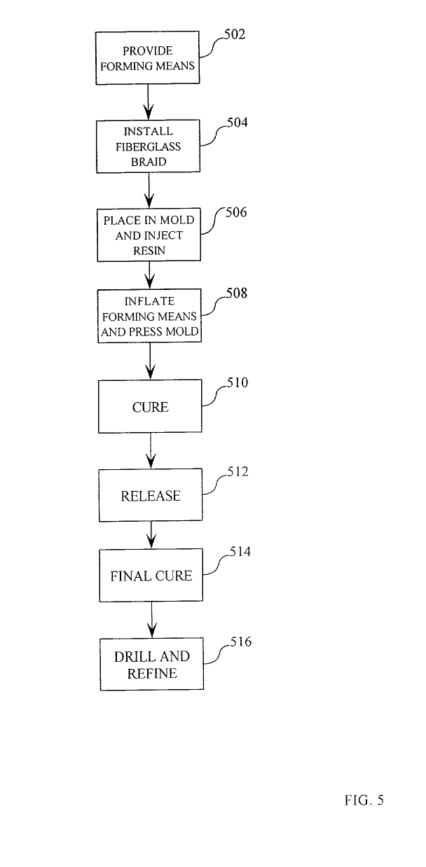

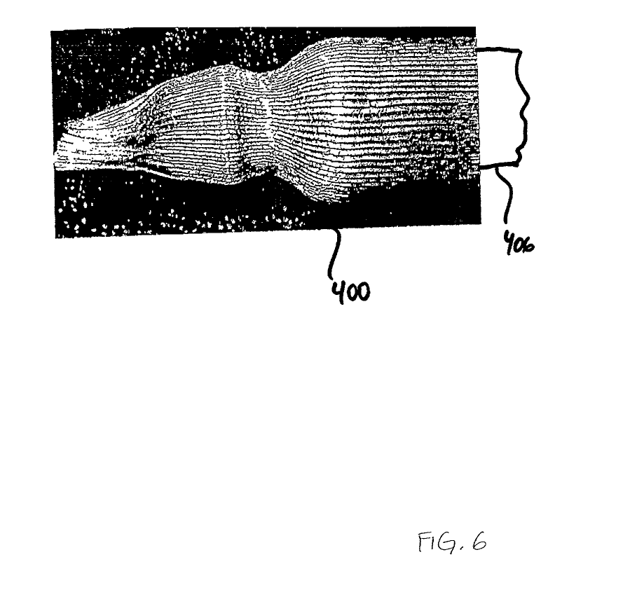

FIG. 5 shows a flow diagram illustrating the preferred method in accordance with the invention herein. As illustrated at 502, a forming means, such as an elongated inflatable bladder 406, is provided and partially inflated or stiffened. At 504, the tubular fiberglass braided structure 400 is installed over the forming means 406 so that the longer fiberglass fibers 408 are aligned generally along the length of the forming means 406, and so that the fibers 408 may be aligned along the longest dimensional length of the finished composite leaf spring. An illustration of the positioning of the fiberglass tube 400 mounted over a form is shown in FIG. 6. As shown in the Figure, the fibers are positioned along the length of the form and allowed to extend slightly past the ends of the form. Other arrangements of the fibers on the form are possible, but it has been shown that this preferred arrangement provides the most longitudinal strength to the final leaf spring as presently contemplated. The installation may be performed manually by hand via one or more technicians, or automatically via a sleeve-installation type apparatus.

Returning now to FIG. 5, after the fiber tube structure 400 is installed at 504, the form and the fibers are placed within an exterior forming mold 420, such as that shown in FIG. 4 above. Resin, such as epoxy or other suitable medium known in the art, is then applied through injection at 506. If desired, additional fiberglass or other structural composite fibers may be added to over the forming means at this stage to increase the strength or rigidity of the final product. Care must be taken to ensure that the resin is fully infused among the glass fibers to ensure adequate structural integration of the fiber and resin components.

At step 508, the exterior forming mold is closed, and the forming means may be inflated so that the resin and matrix are pressed against the walls of the mold. The resin is allowed to cure and harden to a sufficient hardness at step 510, and the leaf spring is then released from the exterior forming mold at 512. Finally, the interior forming means is deflated or otherwise released and removed from the interior of the leaf spring, preferably through the ends of the spring. Final curing may then be performed at step 514, and drilling and other structural refinements can be made to the spring at step 516.

Prototypes and design changes may be implemented quickly, and the process allows more flexibility in design than prior art methods. Furthermore, the resulting composite transverse spring is of significantly lighter weight.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

I claim:

1. A method for manufacturing a transverse leaf spring, said method comprising the steps of:
providing a forming means and a mold adapted to receive said forming means;
installing a pre-braided tubular fiberglass structure over said forming means, said braid structure comprising a plurality of elongated fibers arranged to form an elongated, elastic tubular structure;
placing said forming means and said braid structure into a mold cavity within said mold;
injecting a resin material into said mold to cover said fibers; and
curing said resin to create an integrated leaf spring component.

2. The method of claim 1 further comprising the step of applying pressure between said forming means and interior walls of said mold to press said fiberglass structure and said resin material against said walls.

3. The method of claim 2 wherein said forming means further comprises an elastomeric bladder adapted to fit closely within said mold cavity.

4. The method of claim 3 wherein said step of applying pressure further comprises inflating said bladder when in said mold cavity.

5. The method of claim 1 further comprising the steps of removing said component from said mold cavity and curing said component outside of said cavity.

6. The method of claim 1 wherein said tubular fiberglass structure is radially and longitudinally elastic.

7. A system for manufacturing a transverse leaf spring, said system comprising:
forming means having a shape corresponding to said leaf spring;
means for placing a pre-braided tubular fiberglass structure over said forming means, said braid structure comprising a plurality of elongated fibers arranged to form an elongated, elastic tubular structure;
a mold cavity adapted to receive said forming means and said braid structure; and
means for injecting a resin material into said mold cavity.

8. The system of claim 7 wherein said forming means further comprises an elastomeric bladder adapted to fit closely within said mold cavity.

9. The system of claim 7 wherein said means for placing a pre-braided structure further comprises a manual installer.

10. The system of claim 7 wherein said tubular fiberglass structure further comprises a plurality of fiberglass fibers extending helically in an interwoven fashion in a tubular shape.

11. A method for manufacturing a transverse leaf spring, said method comprising the steps of:
providing a braided fiber structure comprising a plurality of elongated fibers arranged to form an elongated, elastic tubular structure;
integrating a resin material into said fiber structure to form a hollow, molded spring shape; and
curing said shape.

12. The method of claim 11 wherein said plurality of elongated fibers are formed from groups of generally aligned, multiple strands of fibers, each of said groups being interwoven into said braided fiber structure.

13. The method of claim 12 wherein a plurality of said groups extend helically around said structure to form said tubular shape.

14. The method of claim 11 further comprising the step of providing a molding device for holding said braided fiber structure.

15. A composite transverse leaf spring comprising:
a braided fiber structure comprising a plurality of elongated fibers arranged to form an elongated, elastic tube, said tube defining a substantially hollow interior extending susbstantially the length of said fiber structure; and
a resin material integrated with said fiber structure to form a leaf spring shape having a substantially hollow interior and tapered ends, said tapered ends adapted to pivotally attach to axle components of a vehicle.
